(19) United States
(12) Patent Application Publication
(10) Pub. No.: US 2025/0211651 A1
(43) Pub. Date: Jun. 26, 2025

(54) MICROSERVICE DESCRIPTORS MANAGEMENT IN A CLOUD ENVIRONMENT

(71) Applicant: SAP SE, Waldorf (DE)

(72) Inventors: Le Zhang, Xi'an (CN); Yu Wang, Xi'an (CN); Moritz Semler, Spechbach (DE); Haoxing Hou, Xi'an (CN); Daping Wang, Xi'an (CN)

(21) Appl. No.: 18/391,338

(22) Filed: Dec. 20, 2023

(51) Int. Cl. H04L 67/51; G06F 11/32; H04L 9/32

(52) U.S. Cl. CPC H04L 67/51; G06F 11/321; H04L 9/3213

(57) ABSTRACT

Provided herein is a method, wherein the method comprises in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice; generating a token to identify the microservice; generating a unit for the microservice, wherein the unit comprises the properties associated with the microservice and the token for the microservice; and storing, in a registry, the unit in a chronological sequence based on the dependencies of the microservice with respect to one or more other microservices.

### TECHNICAL FIELD

The subject matter described herein relates generally to cloud services and more specifically to microservice descriptors management in cloud services.

### BACKGROUND

Microservices architecture is a method of developing software systems that are made up of independently deployable, modular microservices. Each microservice runs a specific process and communicates through a well-defined, lightweight mechanism to serve a business goal. Cloud environments provide a platform for deploying and managing applications and services through the internet. These environments can be public, private, or hybrid, and offer a variety of services and microservices such as computing power, storage, and analytics. Cloud environments are designed to be scalable and flexible, allowing for the deployment of a wide range of applications and services.

### SUMMARY

Systems, methods, and articles of manufacture, including computer program products, are provided for microservice descriptors management in a cloud environment. In one aspect, there is provided a system. The system may include at least one data processor and at least one memory. The at least one memory may store instructions that result in operations when executed by the at least one data processor. The operations may include: in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice; generating a token to identify the microservice; generating a unit for the microservice, wherein the unit comprises the properties associated with the microservice and the token for the microservice; and storing, in a registry, the unit in a chronological sequence based on the dependencies of the microservice with respect to one or more other microservices.

A computer-implemented method may include: in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice; generating a token to identify the microservice; generating a unit for the microservice, wherein the unit comprises the properties associated with the microservice and the token for the microservice; and storing, in a registry, the unit in a chronological sequence based on the dependencies of the microservice with respect to one or more other microservices.

A non-transitory computer-readable medium storing instructions, which when executed by at least one data processor, result in operations including: in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice; generating a token to identify the microservice; generating a unit for the microservice, wherein the unit comprises the properties associated with the microservice and the token for the microservice; and storing, in a registry, the unit in a chronological sequence based on the dependencies of the microservice with respect to one or more other microservices.

In some variations of the methods, systems, and non-transitory computer readable media, one or more of the following features can optionally be included in any feasible combination. In some variations, the operations further include providing a visualization of the microservice that indicates an impact of the microservice when a system failure occurs. In some variations, the operations further include deploying the unit in response to a deployment request, wherein the deploying is in accordance with the dependencies of the microservice. In some variations, the registry is a centralized registry that manages, based on a timeline ordered data structure, a plurality of units associated with a plurality of microservices. In some variations, the operations further include updating the properties within the descriptor of the microservice in response to changes in any of the configurations, the dependencies, or the feature toggles. In some variations, the token is a non-fungible token. In some variations, the feature toggles associated with the microservice enable or disable one or more functionalities for the microservice without altering code of the microservice.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a block diagram illustrating a system for microservice descriptors management in a cloud service, in accordance with some example embodiments;

FIG. 2A depicts a block diagram illustrating a cloud complete microservice invoking assembler for facilitating at least one or more operations for microservice descriptors management in a cloud service, in accordance with some example embodiments;

FIG. 2B depicts a diagram illustrating data structures facilitating microservice descriptors management in a cloud service, in accordance with some example embodiments;

FIG. 3A depicts a block diagram illustrating a system for microservice descriptors management in a cloud service, in accordance with some example embodiments;

FIG. 3B depicts a diagram illustrating data structures facilitating microservice descriptors management in a cloud service, in accordance with some example embodiments;

FIG. 3C depicts a block diagram illustrating a system for microservice descriptors management in a cloud service, in accordance with some example embodiments;

FIG. 4 depicts a block diagram illustrating a computing system consistent with implementations of the current subject matter, and

FIG. 5 depicts a flowchart diagram illustrating a process for microservice descriptors management in a cloud service, consistent with implementations of the current subject matter.

When practical, similar reference numbers denote similar structures, features, or elements.

### DETAILED DESCRIPTION

In cloud computing, managing microservices presents challenges such as complex orchestration, dependency tracking, and real-time monitoring. Existing systems allow applications to define microservices through a manual process with serial interfaces. This manual method of construction and deployment of microservices can lead to randomized errors, complicating the detection of overall service stacks and root cause analysis. As the microservice invoking stack is tracked and analyzed at every runtime for refreshing deployment and configuration evaluation, it becomes challenging to predict and confirm proactive microservice anomalies. To align with the self-service microservice weaving mechanism, flexible toggle-based microservice may be provided to facilitate dependency and topology tooling.

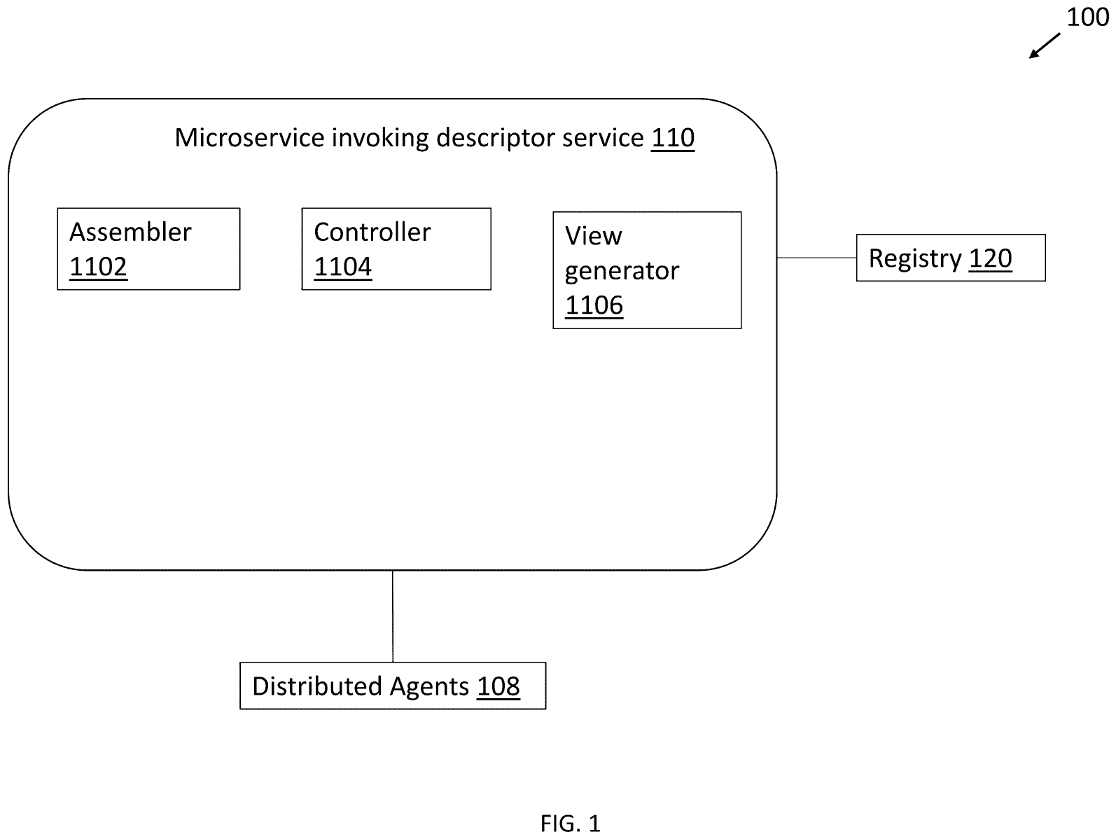

FIG. 1 depicts a block diagram illustrating a system 100 for microservice descriptors management in a cloud service, in accordance with some example embodiments. FIG. 1 illustrates the architecture of the microservice invoking descriptor service 110 on a cloud service (e.g., SAP HANA Cloud, Amazon Web Services (AWS), Microsoft Azure, Google Cloud Platform (GCP), IBM Cloud, etc.). In some embodiments, the microservices may include independently deployable services that are designed to perform specific functions within a cloud-based architecture, each may be running in its own process and communicating with mechanisms including an HTTP-based application programming interface (API). This architecture enables the construction, management, and sharing of candidate descriptors for the microservices. In some embodiments, the descriptors may include metadata representations that include the properties, wherein the properties include configurations, dependencies, and feature toggles of microservices. The descriptors may serve as a blueprint for managing their deployment, interaction, and lifecycle within the cloud-based architecture. In some embodiments, the system 100 may be toggle-based, wherein the toggle refers to a mechanism that allows for the dynamic enabling or disabling of specific features or functionalities within a microservice without the need to alter the underlying codebase. This toggle-based system may facilitate flexible configuration and rapid adaptation to changing requirements or operational conditions.

The assembler 1102 (which is a component of the microservice invoking descriptor service 110) may utilize the registry 120 to generate chronologically ordered microservice units. These units are organized in a linked manner, and a hash identity with a non-fungible token is attached to each microservice. In some embodiments, the units include configurations, dependencies, feature toggles, and the token for the microservice. These units may be shared and viewed not just by application construction groups with defined management policies on the cloud service, but also by other relevant parties. The units of these candidate microservices are gathered from distributed agents 108 operating on microservices within the cloud service. In some embodiments, in response to a deployment request, the system may deploy the units in accordance with the dependencies of the microservice.

As depicted in FIG. 1, the microservice invoking descriptor service 110 may include service-side modules, engines, and/or functionalities. For instance, the microservice invoking descriptor service 110 may comprise an assembler 1102 for generating units associated with microservices, a registry 120 for storing and managing these descriptors and unites for microservices, a controller 1104 for assembling, dispatching, or sharing microservice invoking units with metadata and configurable attributes, and a view generator 1106 for providing a prospective view of microservices for applications. In some embodiments, the view generator 1106 may provide a visualization of the microservice that indicates an impact of the microservice when a system failure occurs. In some embodiments, the view generator 1106 may provide a prospective visualization of microservices that is configured to evaluate an impact of microservices or detect microservices when a system failure occurs. In some implementations, the microservice invoking descriptor service 110 provides the capability to generate and maintain the assembler 1102 within the distributed and tenant-based cloud service environment. In some embodiment, the descriptors are generated based on a rule-based process or an artificial intelligence-based process. In some embodiments, the present disclosure provides a flexible, toggle-based microservice invoking descriptor service (e.g., microservice invoking descriptor service 110 as discussed in connection with FIG. 1) and related components operating on a cloud service (e.g., SAP HANA Cloud, Amazon Web Services (AWS), Microsoft Azure, Google Cloud Platform (GCP), IBM Cloud, etc.). This service may leverage multiple techniques to record, generate, and register candidate microservices for each cloud service, facilitating timely planning for applications.

In some instances, candidate microservices in a cloud context may be recorded and maintained in a manner that is both complete and flexible. Here, “complete” refers to the comprehensive recording of all relevant data and information pertaining to the microservices, including but not limited to their functionalities, dependencies, and interactions with other services. “Flexible” may refer to the ability to adapt the recording and maintenance process to accommodate changes in the microservices, such as updates, modifications, or the introduction of new services. This comprehensive and adaptable approach allows applications to obtain detailed knowledge and related information about their purchased cloud microservices at any given time span. The microservice invoking descriptor information, which includes the comprehensive and adaptable records of the microservices, can then be retrieved and further consumed when monitoring, analyzing, and planning timely operations.

In some configurations, the registry 120 may serve as a centralized registry to store and manage the corresponding timeline ordered data structures for the linked microservice invoking descriptor generated by the assembler 1102. In some embodiments, the timeline ordered data structure refers to an organizational scheme for data that arranges information based on chronological order. In the context of microservices, this may mean that the descriptors, tokens, and other related data are stored in a sequence that reflects the temporal order in which deployment events and other related actions occurred. In some embodiments, this may aid to understanding the evolution of microservice configurations, dependencies, and feature toggles over time, and for managing the complex interdependencies between different microservices in a cloud environment.

From the context and environment of distributed microservice nodes, the linked sequential data structures are constructed within the registry 120 to ensure the proper tradeoffs of distributed information under the time-wise logical order property. In some cases, the hierarchical topology of the actual complex microservices may reference the actual runtime in chronological order, including the timestamp-based data structure and link-support feature-toggle aware data structure from this registry service.

In some implementations, the controller 1104 has the capability to manage, dispatch, or share the microservice invoking descriptor units with requisite metadata and configurable attributes to the permission-granted roles within cloud service landscapes. This controller 1104 may enhance the cloud service microservice management capacity with additional functionality to reference and share the timely and toggle-based microservice units across the cloud environment. The controller 1104 may store and manage various cross-field microservice units owned and shared by cloud service application landscape owners and related application construction groups under specified configuration policies.

In some instances, the view generator 1106 may collaborate with assembler 1102 to construct and provide a collective microservice view for group-defined applications and specific application implementation groups from a cloud service. In some embodiments, the view generator 1106 may provide a flexible and trackable capability to let applications have a prospective microservice view when a staged and defined microservice sequence is completed from cloud service construction groups. This generated and constructed microservice view could be used afterwards to evaluate the microservice impact or detect microservice when a system failure occurs, especially in a proactive way to detect anomalies and evaluate the potential impact when overall performance is downgraded. The microservice view could be encrypted and toggle-based according to multi-level construction and microservice weaving policies. It may assist applications in gaining more technical confidence and detecting handling approaches when cloud microservice construction work encounters unexpected issues and related damages to the application's hybrid-cloud infrastructures.

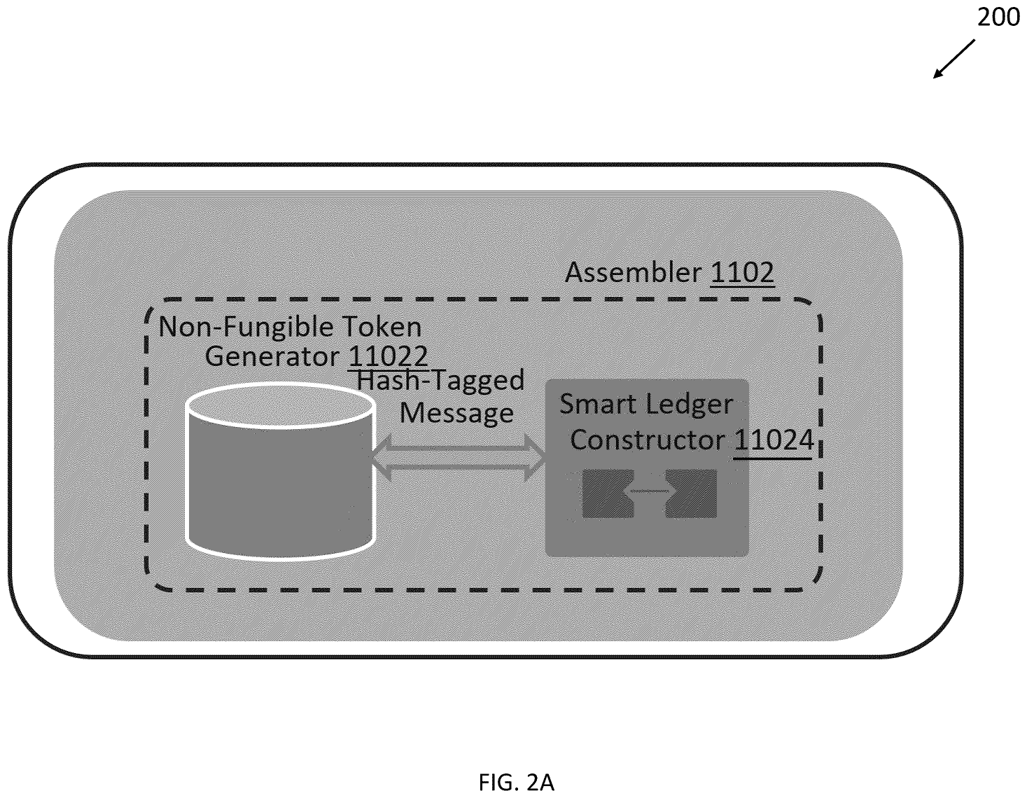

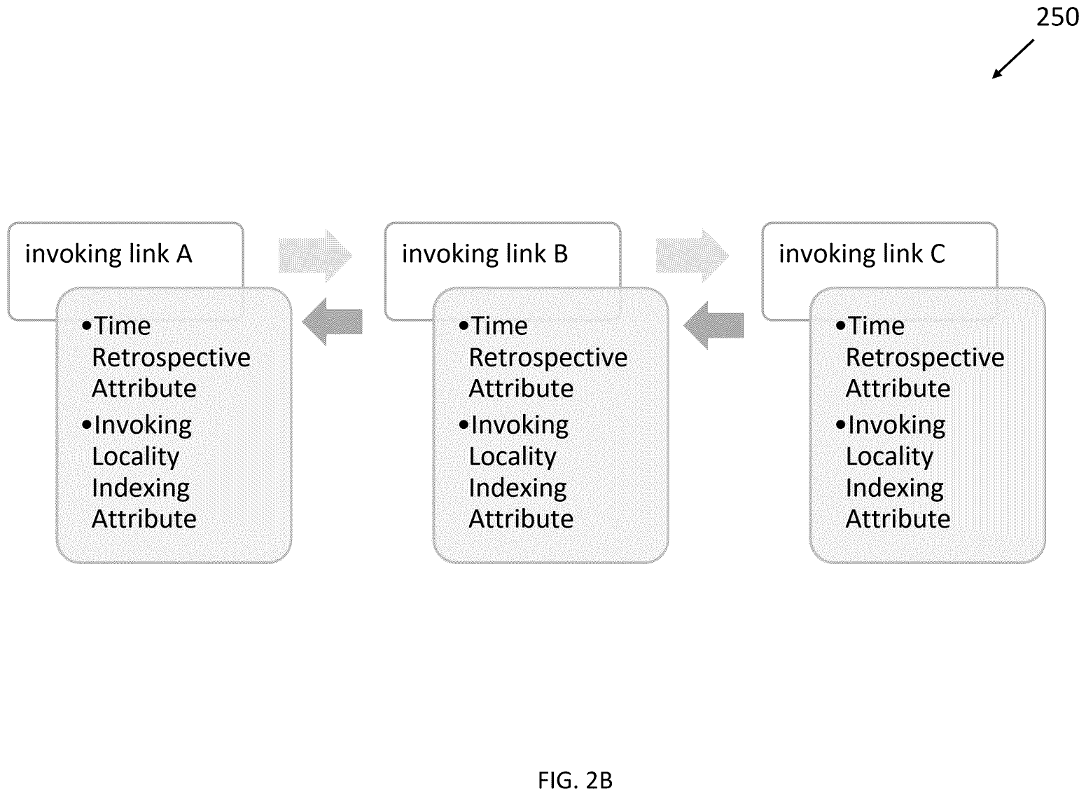

FIG. 2A depicts a block diagram 200 illustrating an assembler 1102 for facilitating at least one or more operations for microservice descriptors management in a cloud service, in accordance with some example embodiments. As shown in FIG. 2A, the assembler 1102 may provide the capability to generate microservice invoking descriptors in a complete manner when candidate microservices are spawned from a cloud service platform. In some embodiments, a unit (for example, a complete microservice invoking descriptor unit) may be reflected to one feature-toggle-based selection plan administrated by a cloud service application construction. As shown in FIG. 2A, the non-fungible token generator 11022 may assume the responsibility to offer identified tokens for each microservice and/or each microservice unit, which may record the candidate microservice data from cloud service construction groups. For the distributed runtime environment, the non-fungible tokens are attached to each token data structure. In some embodiments, the smart ledger constructor 11024 may have the functionality to collect the distributed agent data with respect to candidate microservice information with the data structures and links that may repackage the related microservice units into ledger queues for specific tenant-based construction groups.

FIG. 2B depicts a diagram illustrating data structures 250 facilitating microservice descriptors management in a cloud service, in accordance with some example embodiments. In some embodiments, the data structures 250 In some implementations, the data structures 250 may include indexing-based invoking service dependency links. In addition to traditional service topology and dependency linked data, two additional data structures may be appended to expedite the generation result. The time retrospective attribute can contribute to the invoking relative time before or after a microservice in the self-defined weaving context. This quick search indexing attribute is designed to provide the calculated time value when comparing microservice invoking links to justify the correctness and integrity of microservice dependency. The invoking locality indexing attribute can be used for quick search and identification on occasions when related microservices within a horizontal scaling resource-shared pool detect potential performance issues or anomalies when allocation policy or the situation of cloud resource consumption changes and impacts application scenarios.

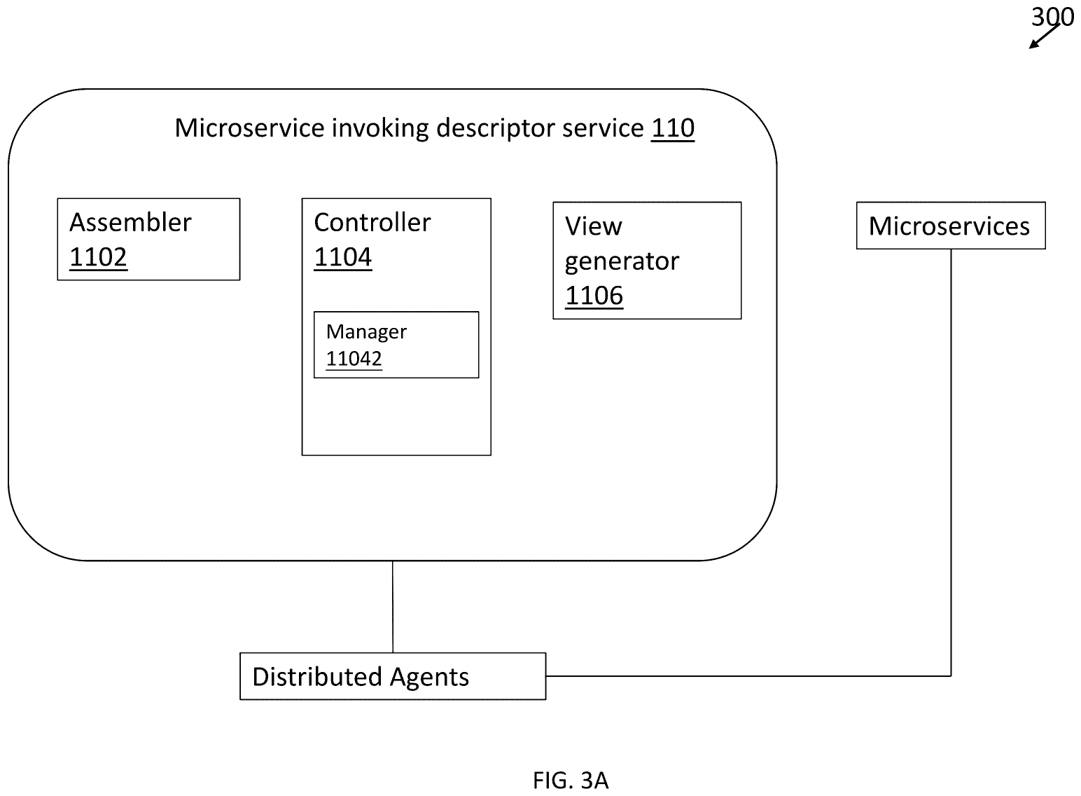

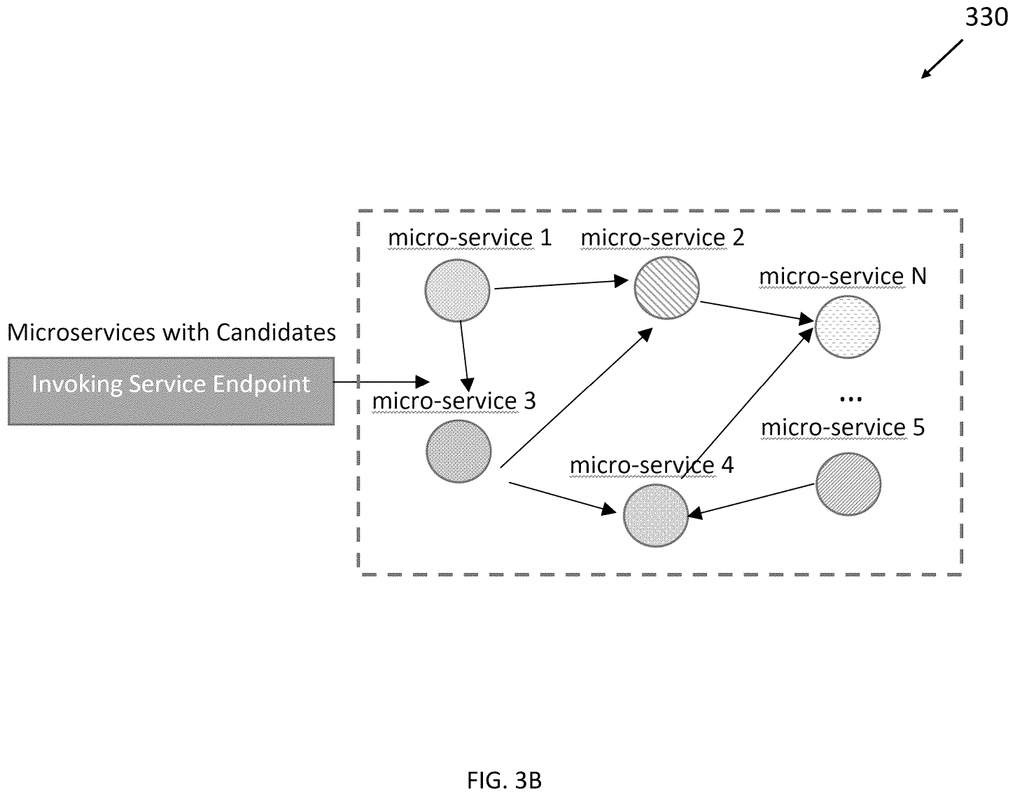

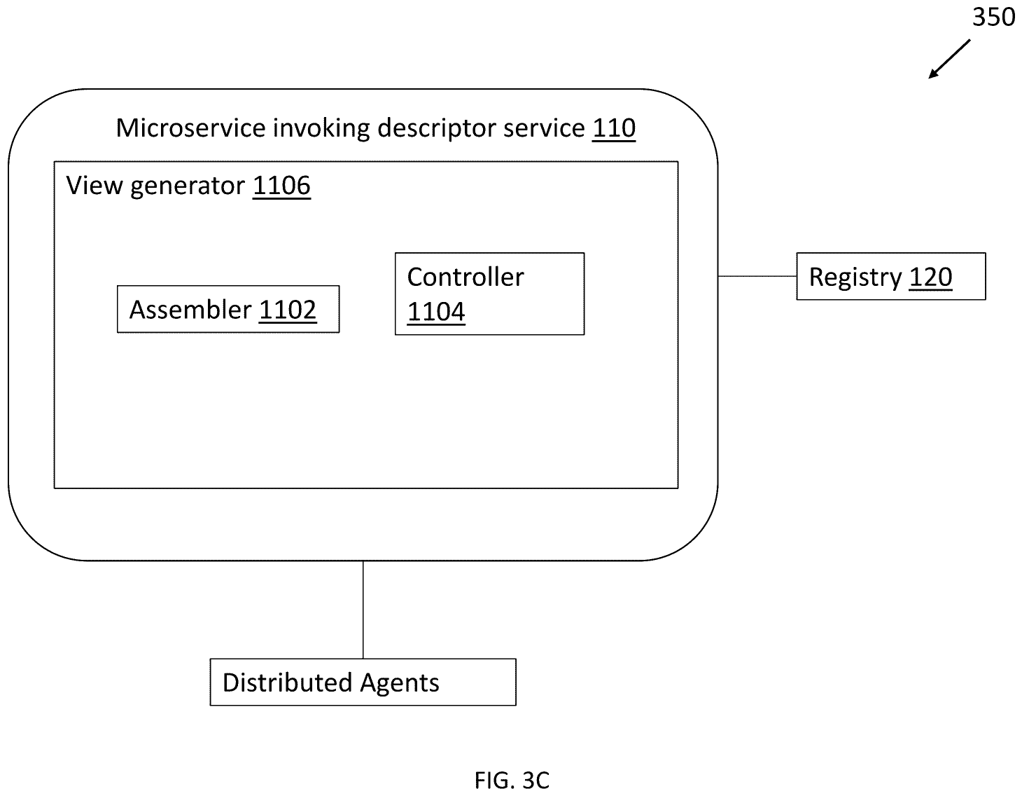

FIG. 3A depicts a block diagram 300 illustrating a system for microservice descriptors management in a cloud service, in accordance with some example embodiments. As shown in FIG. 3A, a detailed illustration of the controller 1104 for a cloud service is presented. The controller 1104 may include the capability to manage, dispatch, or share the microservice invoking descriptor units with the requisite metadata and configurable attributes to the roles granted permission within cloud service landscapes. In some implementations, the feature-toggle-based tunnel management framework may be introduced to make sure the integrity and completeness of connection and runtime information. In some embodiments, the controller 1104 may provide the functionality to store and manage various cross-field microservice invoking descriptors owned and shared by cloud service landscape owners and related application construction groups under specified IT configuration policies. The manager 11042 (e.g., linked microservice unit manager) is a component of the controller 1104. In some embodiments, the manager 11042 may be configured to perform serial tasks. For example, these serial tasks may include fetching and managing cross-field candidate microservice definitions and descriptions, maintaining the identity lifecycle of candidate microservice invoking descriptors, and/or managing the access requests from separate applications for candidate manipulations and analysis duties.

FIG. 3B depicts a diagram illustrating data structures 330 facilitating microservice descriptors management in a cloud service, in accordance with some example embodiments. As shown in FIG. 3B, a generative cross-field suffix graph is introduced to facilitate the exchange of microservice dependency metadata in a cross-field manner. In a hybrid cloud environment for example, weaving feature-toggle-based microservices requires complex and hierarchical access information along with various configuration information. The related invoking descriptor may have to capture and track these hybrid cloud tokens and other candidate information for failure handling scenarios such as rollback, failover, isolation, scaling, and others. The generative suffix graph can be beneficially used to manage microservice invoking units with properly defined suffixes. This allows for partitioning the overall graph in an easily operated manner to flexibly join, dislocate, rejoin, and refactor when feature-toggle selection or other application self-service operations occur.

FIG. 3C depicts a block diagram illustrating a system 350 for microservice descriptors management in a cloud service, in accordance with some example embodiments. As shown in FIG. 3C, a view generator 1106 (e.g., a collective microservice view generator, a microservice view dispatcher and generator, etc.) for a cloud service may include the assembler 1102 and/or the cross-filed operation controller 1104. The view generator 1106 (e.g., a microservice view dispatcher and generator) is capable of providing applications with a perspective from microservice views when a staged and defined microservice sequence is completed by cloud service construction groups. In some embodiments, it is preferred to apply the runtime composite-view technique to capture and generate from the segmentation of complete microservice invoking descriptor under peer-to-peer cloud environment. This could benefit from attentively maintained microservice view defined by cloud service construction groups and application-defined monitoring service specifications. This approach may benefit the optimized localization for hybrid-cloud environment suitable for the actual application context from enterprise applications and related cloud microservice management solutions. This generated and constructed microservice view can be used afterwards to evaluate the impact of the microservice or detect a microservice when a system failure occurs. The microservice views may be organized in a lineage-based hierarchical data structure. When applications plan to reference a specific candidate microservice from the cloud service for issue tracking, they can refer to the microservice views accordingly. Applications can also snapshot the microservice views and attempt to detect the actual scenes when an anomaly occurs in candidate microservices after the application construction commits the tasks with timely delivery.

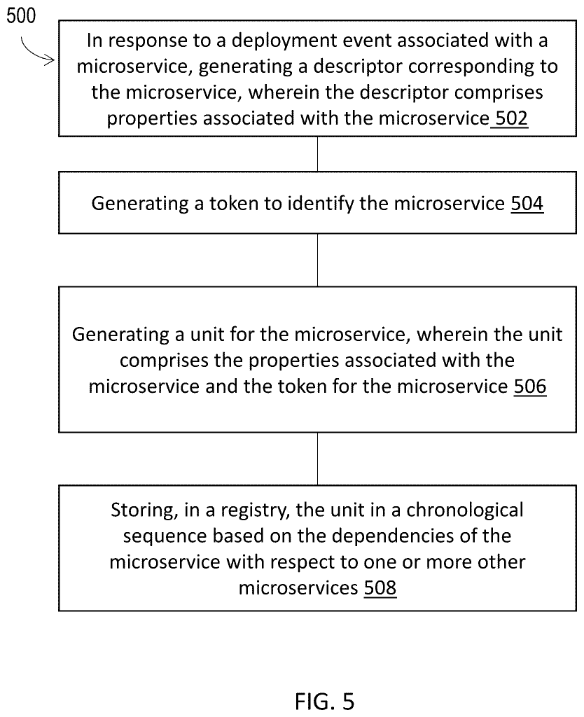

FIG. 5 depicts a flowchart diagram 500 illustrating a process for microservice descriptors management in a cloud service, consistent with implementations of the current subject matter. The process commences with operation 502, where the method is initiated by generating a descriptor for a microservice in response to a deployment event associated with that microservice. This descriptor encapsulates properties related to the microservice, which include configurations, dependencies, and feature toggles. Following this, in operation 504, the system generates a token to uniquely identify the microservice, further facilitating the management and tracking of the microservice within the cloud environment. Next the process may proceed to operation 506, where a unit for the microservice is created. This unit integrates the properties of the microservice, as detailed in the descriptor, along with the uniquely generated token. The unit may serve as a representation of the microservice for subsequent deployment and management tasks. Subsequently, in operation 508, the unit is stored within a registry. The storage process is designed to place the unit in a chronological sequence that is determined by the dependencies of the microservice in relation to other microservices within the system. This chronological ordering may ensure that dependency relationships are managed effectively.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A method comprises: in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice; generating a token to identify the microservice; generating a unit for the microservice, wherein the unit comprises the properties associated with the microservice and the token for the microservice; and storing, in a registry, the unit in a chronological sequence based on the dependencies of the microservice with respect to one or more other microservices.

Example 2: The method of Example 1, further comprising providing a visualization of the microservice that indicates an impact of the microservice when a system failure occurs.

Example 3: The method of any of Examples 1-2, further comprising deploying the unit in response to a deployment request, wherein the deploying is in accordance with the dependencies of the microservice.

Example 4: The method of any of Examples 1-3, wherein the registry is a centralized registry that manages, based on a timeline ordered data structure, a plurality of units associated with a plurality of microservices.

Example 5: The method of any of Examples 1-4, further comprising updating the properties within the descriptor of the microservice in response to changes in any of the configurations, the dependencies, or the feature toggles.

Example 6: The method of any of Examples 1-5, wherein the token is a non-fungible token.

Example 7: The method of any of Examples 1-6, wherein the feature toggles associated with the microservice enable or disable one or more functionalities for the microservice without altering code of the microservice.

Example 8: A system, comprising: at least one data processor, at least one memory, at least one memory may store instructions that result in operations when executed by the at least one data processor, the operations comprise: in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice; generating a token to identify the microservice; generating a unit for the microservice, wherein the unit comprises the properties associated with the microservice and the token for the microservice; and storing, in a registry, the unit in a chronological sequence based on the dependencies of the microservice with respect to one or more other microservices.

Example 9: The system of Example 8, wherein the operations further comprise providing a visualization of the microservice that indicates an impact of the microservice when a system failure occurs.

Example 10: The system of any of Examples 8-9, wherein the operations further comprise deploying the unit in response to a deployment request, wherein the deploying is in accordance with the dependencies of the microservice.

Example 11: The system of any of Examples 8-10, wherein the registry is a centralized registry that manages, based on a timeline ordered data structure, a plurality of units associated with a plurality of microservices.

Example 12: The system of any of Examples 8-11, wherein the operations further comprise updating the properties within the descriptor of the microservice in response to changes in any of the configurations, the dependencies, or the feature toggles.

Example 13: The system of any of Examples 8-12, wherein the token is a non-fungible token.

Example 14: The system of any of Examples 8-13, wherein the feature toggles associated with the microservice enable or disable one or more functionalities for the microservice without altering code of the microservice.

Example 15: A non-transitory computer-readable medium storing instructions, which when executed by at least one data processor, result in operations comprising: in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice; generating a token to identify the microservice; generating a unit for the microservice, wherein the unit comprises the properties associated with the microservice and the token for the microservice; and storing, in a registry, the unit in a chronological sequence based on the dependencies of the microservice with respect to one or more other microservices.

Example 16: The non-transitory computer-readable medium of Example 15, wherein the operations further comprise providing a visualization of the microservice that indicates an impact of the microservice when a system failure occurs.

Example 17: The non-transitory computer-readable medium of any of Examples 15-16, wherein the operations further comprise deploying the unit in response to a deployment request, wherein the deploying is in accordance with the dependencies of the microservice.

Example 18: The non-transitory computer-readable medium of any of Examples 15-17, wherein the registry is a centralized registry that manages, based on a timeline ordered data structure, a plurality of units associated with a plurality of microservices.

Example 19: The non-transitory computer-readable medium of any of Examples 15-18, wherein the operations further comprise updating the properties within the descriptor of the microservice in response to changes in any of the configurations, the dependencies, or the feature toggles.

Example 20: The non-transitory computer-readable medium of any of Examples 15-19, the token is a non-fungible token.

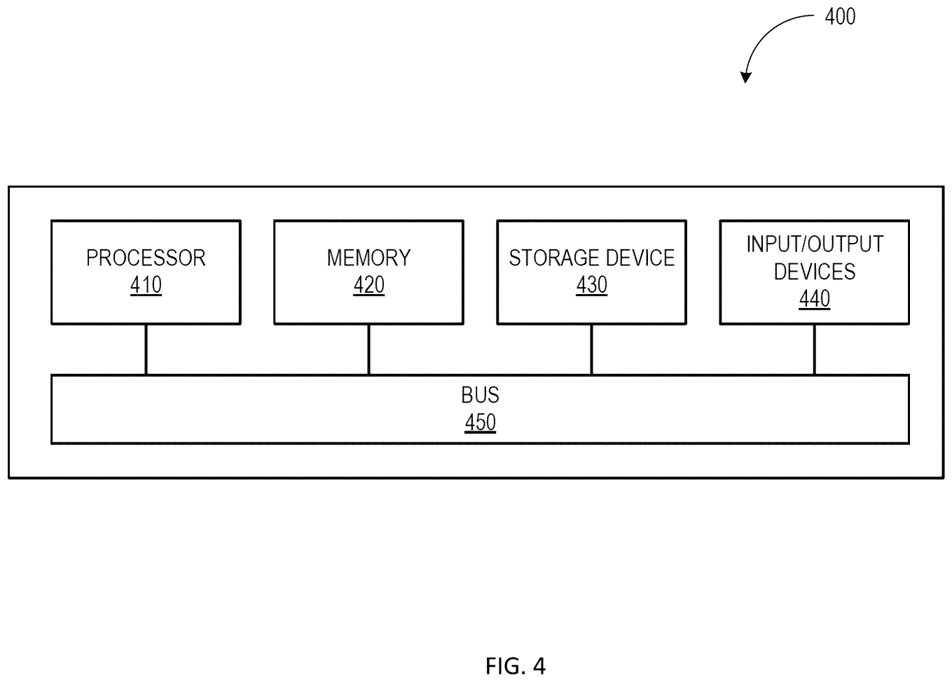

FIG. 4 depicts a block diagram illustrating a computing system 400 consistent with implementations of the current subject matter. As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The processor 410 is capable of processing instructions for execution within the computing system 400. Such executed instructions can implement one or more components of, for example, the service 110. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a solid-state device, a floppy disk device, a hard disk device, an optical disk device, a tape device, and/or any other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub combinations of the disclosed features and/or combinations and sub combinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A method, comprising:
in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice;
generating a token to identify the microservice;
generating a unit for the microservice, wherein the unit comprises the properties associated with the microservice and the token for the microservice; and
storing, in a registry, the unit in a chronological sequence based on the dependencies of the microservice with respect to one or more other microservices.

2. The method of claim 1, further comprising providing a visualization of the microservice that indicates an impact of the microservice when a system failure occurs.

3. The method of claim 1, further comprising deploying the unit in response to a deployment request, wherein the deploying is in accordance with the dependencies of the microservice.

4. The method of claim 1, wherein the registry is a centralized registry that manages, based on a timeline ordered data structure, a plurality of units associated with a plurality of microservices.

5. The method of claim 1, further comprising updating the properties within the descriptor of the microservice in response to changes in any of the configurations, the dependencies, or the feature toggles.

6. The method of claim 1, wherein the token is a non-fungible token.

7. The method of claim 1, wherein the feature toggles associated with the microservice enable or disable one or more functionalities for the microservice without altering code of the microservice.

8. A system, comprising:
at least one data processor,
at least one memory, at least one memory may store instructions that result in operations when executed by the at least one data processor, cause operations comprising:
in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice;
generating a token to identify the microservice;
generating a unit for the microservice, wherein the unit comprises the properties associated with the microservice and the token for the microservice; and
storing, in a registry, the unit in a chronological sequence based on the dependencies of the microservice with respect to one or more other microservices.

9. The system of claim 8, wherein the operations further comprise providing a visualization of the microservice that indicates an impact of the microservice when a system failure occurs.

10. The system of claim 8, wherein the operations further comprise deploying the unit in response to a deployment request, wherein the deploying is in accordance with the dependencies of the microservice.

11. The system of claim 8, wherein the registry is a centralized registry that manages, based on a timeline ordered data structure, a plurality of units associated with a plurality of microservices.

12. The system of claim 8, wherein the operations further comprise updating the properties within the descriptor of the microservice in response to changes in any of the configurations, the dependencies, or the feature toggles.

13. The system of claim 8, wherein the token is a non-fungible token.

14. The system of claim 8, wherein the feature toggles associated with the microservice enable or disable one or more functionalities for the microservice without altering code of the microservice.

15. A non-transitory computer-readable medium storing instructions, which when executed by at least one data processor, result in operations comprising:
in response to a deployment event associated with a microservice, generating a descriptor corresponding to the microservice, wherein the descriptor comprises properties associated with the microservice, wherein the properties comprise configurations for the microservice, dependencies of the microservice with respect to one or more other microservices, and feature toggles associated with the microservice;
generating a token to identify the microservice;
generating a unit for the microservice, wherein the unit comprises the properties associated with the microservice and the token for the microservice; and
storing, in a registry, the unit in a chronological sequence based on the dependencies of the microservice with respect to one or more other microservices.

16. The non-transitory computer-readable medium of claim 15, wherein the operations further comprise providing a visualization of the microservice that indicates an impact of the microservice when a system failure occurs.

17. The non-transitory computer-readable medium of claim 15, wherein the operations further comprise deploying the unit in response to a deployment request, wherein the deploying is in accordance with the dependencies of the microservice.

18. The non-transitory computer-readable medium of claim 15, wherein the registry is a centralized registry that manages, based on a timeline ordered data structure, a plurality of units associated with a plurality of microservices.

19. The non-transitory computer-readable medium of claim 15, wherein the operations further comprise updating the properties within the descriptor of the microservice in response to changes in any of the configurations, the dependencies, or the feature toggles.

20. The non-transitory computer-readable medium of claim 15, wherein the token is a non-fungible token.
